(19) United States
(12) Patent Application Publication
(10) Pub. No.: US 2006/0235843 A1
(43) Pub. Date: Oct. 19, 2006

(54) Method and system for semantic search and retrieval of electronic documents

(75) Inventors: Timothy A. Musgrove, San Francisco, CA (US); Robin H. Walsh, San Francisco, CA (US)

Correspondence Address: NIXON PEABODY, LLP, 401 9TH STREET, NW, SUITE 900, WASHINGTON, DC, 20004-2128, US

(73) Assignee: TextDigger, Inc., Morgan Hill, CA (US)

(21) Appl. No.: 11/343,084

(22) Filed: Jan. 31, 2006

Related U.S. Application Data
(60) Provisional application No. 60/647,766, filed on Jan. 31, 2005.

(51) Int. Cl. G06F 17/30

(52) U.S. Cl. 707/6

(57) ABSTRACT

A system and method for semantic search for electronic documents stored on a computer readable media, and providing a search result in response to a query. The system includes a corpus including a plurality of electronic documents that are domain tagged at a document level and analyzed based on the tags to identify word usage patterns. An index of word usage patterns is provided that indexes the plurality of documents in the corpus according to their word usage patterns. The system also includes a query pre-processing module that receives a query from a user, and analyzes the query to determine probable word usage patterns in the query. The system further includes a processor that uses the index to identify documents having word usage patterns that matches the probable word usage patterns in the query as a candidate electronic document, and retrieves the candidate electronic document.

This application claims priority to U.S. Provisional Application No. 60/647,766, filed Jan. 31, 2005, the contents of which are incorporated herein by reference.

### BACKGROUND OF THE INVENTION

1. Field of the Invention

The present invention is directed to a system and method for semantic search and retrieval of electronic documents.

2. Description of Related Art

Electronic searching across large document corpora is one of the most broadly utilized applications on the Internet, and in the software industry in general. Regardless of whether the sources to be searched are a proprietary or open-standard database, a document index, or a hypertext collection, and regardless of whether the search platform is the Internet, an intranet, an extranet, a client-server environment, or a single computer, searching for a few matching texts out of countless candidate texts, is a frequent need and an ongoing challenge for almost any application.

One fundamental search technique is the keyword-index search that revolves around an index of keywords from eligible target items. In this method, a user's inputted query is parsed into individual words (optionally being stripped of some inflected endings), whereupon the words are looked up in the index, which in turn, points to documents or items indexed by those words. Thus, the potentially intended search targets are retrieved. This sort of search service, in one form or another, is accessed countless times each day by many millions of computer and Internet users. It is, for example, built into database kits offered by companies such as Oracle® and IBM®, which are utilized by many of the Fortune® 1000 companies for internal data management; it is built into the standard help file utility on the Windows® operating system, which is used on most personal computers today; and it is the basis of the Internet search services provided by Lycos®, Yahoo®, and Google®, used by tens of millions of Internet users daily.

Two main problems of keyword searches are (1) missing relevant documents, and (2) retrieving irrelevant ones. Most keyword searches do plenty of both. In particular, with respect to the first problem, the primary limitation of keyword searches is that, when viewed semantically, keyword searches can skip about 80% of the eligible documents because, in many instances, at least 80% of the relevant information will be indexed in entirely different words than words entered in the original query. Granted, for simple searches with very popular words, and where relevant information is plentiful, this is not much of a problem. But for longer queries, and searches where the relevant phrasing is hard to predict, results can be disappointing.

Some of the questions that arise in this context are:

How can a search engine recognize where there are synonymous words for the query words, e.g. that “mother-daughter matching sleeping gowns” matches “adult-child coordinated night gown set”?

How can a search engine recognize that “hotel room with a view of the Golden Gate Bridge” matches “suite that provides a panorama of the entire Bay Area skyline” where the phrase “Bay Area skyline”, while not synonymous with “Golden Gate Bridge,” is nonetheless very strongly related to it?

The second main problem in keyword search is that, not only do keyword searches overlook relevant matching texts, they also erroneously match irrelevant texts, due largely to the fact that words can be used in different senses.

Examples of questions that arise in this context are:

How can a search engine recognize that “bank an aircraft in high wind” is NOT a match for “His investment bank funded an aircraft company whose high sales brought in a windfall profit,” despite that it has a high correspondence to the series of words in the query?

How can a search engine recognize that “Apple Slashes Price of Newest Macintosh” should match documents concerning personal computers and not the agriculture industry?

The common attempts at this problem revolve around various kinds of popularity ranking, e.g. with Google® the most-linked-to content across the Web, and/or with other search engines, the content that is most searched-for or most clicked-on-in-search-results-pages. However, the popularity is inferred, and there are a number of cases where popularity does not represent the intention of a particular user. Thus, this method, while it is guaranteed to work in a significant number of cases (the most popular ones), is guaranteed also not to work in all the other cases other than the most popular case.

Attempts have been made to address the above described missed relevant documents problem. Probably the most straightforward approach is to automatically add synonyms to a query. This is easily done by simple look-ups in a machine readable thesaurus or “WordNet.” Most common synonyms are added automatically, and search is conducted for the query words as well as the synonyms. Unfortunately, this approach encounters some very significant problems in that:
1. Words have many different senses;
2. Words have many synonyms in each sense;
3. Most synonyms themselves have other senses which are NOT synonymous with the original word.

For example, the word “bank” can mean a financial institution, the edge of a river, the turning of an aircraft, the willingness to believe something (“you can bank on it!”), etc. Taking the second of these senses, the word “turn,” though it can be a valid synonym of “bank,” will also have other senses (such as in “it's your turn” or “the turn of the century”, etc.) which have nothing to do with any of the senses of “bank.” This means that automatically adding all the synonyms of every query term usually creates more irrelevant hits, not fewer. While the synonyms do give the benefit of enabling the search engine to find more relevant information, that effect is overshadowed by the creation of a mountain of additional, irrelevant search results. Thus, adding the synonyms turns out to make matters worse, not better.

The irrelevant result problem is practically the opposite, or the “converse” of the false candidate problem in that instead of missing a document that is relevant, the search engine includes results that are not actually relevant. This usually happens because, again, words can be used in variant senses, meaning that a document can satisfy the query perfectly when viewed from the perspective of a keyword-match rate, but the words in the target document may have been used in different senses from those in the query so that the document is irrelevant. Although this seems to be an “opposite” problem, it really derives from the same fundamental problem which is the inability of keyword search engines to be cognizant of word senses.

Since keyword search engines typically are not even close to being able to determine word senses, the designers of various search engines have come up with other “tricks” or indirect methods of eliminating many of the irrelevant hits. Most of these methods have to do with monitoring user behavior in some degree, and feeding it back into the search engine, or including popularity data in the algorithm for the keyword post-processor. The two major variations of these methods include:
1. Observe which search results are clicked on (and which are not clicked on) by users following a search, and save the information. If exactly (or nearly) the same query is submitted later by the same or another user, recall the information, and use it to promote in rank the items clicked on, and/or demote in rank the items that were not clicked on, in proportion (or in some linear or non-linear function of) the number of times clicked (or not clicked).
2. Observe how many times a page is linked to (or visited by), or how many times the site hosting the page is linked to (or visited by), general users (or especially by users or sites considered “first tier” or “more important”) and uses these numbers to promote or demote the rank of such pages (or sites) in search results, on the grounds the more popular (more visited, more mentioned, more linked-to) sites will in general have more relevant information, than those which are less popular (less visited, more rarely mentioned, seldom linked-to).

There is nothing particularly wrong about either of these methods, but they are inherently a proxy for actual word sense disambiguation. If one knew whether or not the text itself was relevant based on its content, one would use user behavior and popularity only as a supplement (i.e. a “fine tuning” or “tie-breaker”) in ranking and scoring, rather than as a basis for determining search results. Furthermore, these methods can in fact go wrong in numerous ways. First, popular notions about sources can overshadow true relevance. For example, suppose that “HomeDepot.com” is one of the best known brands in home improvement, and one of the most famous websites in this topic area, and suppose that the site does not have content specifically about how to fix a leaky dishwasher, and that a small, not-very-well-known website called “Elmer's Plumbing Tips” has, actually, superbly detailed, accurate, and accessible content about this topic. In this case, there is no doubt that many users, familiar with the brand HomeDepot® and not “Elmer's” Plumbing Tips” will click on HomeDepot® website, and never even give Elmer's a chance. When the search engine picks up this pattern, it ranks HomeDepot® (the less relevant content) even higher, and Elmer's (the more relevant content) even lower. This can happen on both of the aforementioned methods.

In addition, popularity algorithms pit the hottest trends against more stable interests, and pit the larger against the smaller groups of users. Let us suppose that the query “turtle wax” is, in the eyes of 99.9% of those who enter the query, relevant to cleaning and waxing one's vehicle, and not to rock and roll music, or swimsuit models. Let's suppose however that a rock and roll music group has come out with an album titled “turtle wax” with an image on the album cover featuring several swimsuit models. Let's suppose further that a large number of persons entering this query in a particular month, on the Internet, are not looking for car cleaning products, but for the rock album in question.

A middle-aged man John Smith who never listens to rock and roll music, but merely wants to find a wax that will hide the scratches in his truck's paint job, enters “turtle wax” in an Internet search engine, and is stunned to see not one or two, but actually, all ten of the top items on the first page of search results pointing to rock and roll fan sites, concert ticket brokers, poster and memorabilia vendors, and so on. In this case, popularity data has served the interests of the search engine company well, which is mostly delivering millions of rock and roll fans to their desired destinations, and being paid for contextual marketing items. However, it is not serving John Smith's needs when he wants his car wax.

In addition, significant numbers of users can succumb to distraction of irrelevant, but high-interest, content. In the last example, let's suppose that John Smith, after being annoyed by the rock and roll ads provided in response to his search, is nonetheless distracted by the thumbnail image of the swimsuit models shown in the cover of the album for the music group. He would like to see a larger image, just for a second, even though it had nothing to do with his original query (about car wax). He clicks it for a second, satisfies his curiosity, then hits the back button of his browser and resumes his search for a better car wax. Unfortunately, John Smith has done a great disservice to the next person who may be looking for car wax because now the search engine assumes that he was intentionally looking for the rock and roll album cover. Of course, John Smith was not, but was merely susceptible to being distracted by the irrelevant search results. His distraction has, in effect “voted against” his real interests.

The above example illustrates that popularity data can be a self-fulfilling prophecy, when its object has a distracting or intriguing quality about it. In other words, when a search engine deems certain content popular and therefore, ranks it higher, it is, in effect, increasing the exposure of that content all the more. With that increased exposure comes some additional spread of its popularity, which begets in the search engine, an even further increased exposure, and so on. Thus, conventional methods of working around the problem of irrelevant results, rather than tackling the problem head on, have numerous pitfalls.

The two major problems of search (missed candidates and irrelevant results) share some important things in common in that both problems are rooted in the failure to distinguish word senses, and both have had their attempted solutions suffer from creating, in at least some respects, a worse picture rather than a better one for the user. Thus, there exists an unfulfilled need for a system that can address the problem of word sense disambiguation more directly than have the prior attempts in this regard.

In order to appreciate how widespread, and how consternating the problem of polysemy (multiple meaning) of words can be, consider the word senses for the word “Space” which include: Outer space (noun); Real estate “vacant space” (noun); Blank space on a paper such as for signature (noun); Blank space between letters in a sentence (noun); “space the fence posts farther apart, please” (verb); “space my appointments farther apart, please” (temporal application); to go into a trance “he spaced out” (not in most lexicons); Industry niche “competitors in our space” (not in most lexicons). Other examples of common, highly polysemous words are: bank, break, call, dark, date, interest, love, mean, plane, play, stage, time, try, view, window, and thousands of other words.

Conventional methods of word sense disambiguation proposed in the art generally proceed along the following lines:
1. Manually sense-tag corpus of texts (mark each word as to its canonical sense). One will use most of this data as the “training data” while saving a minority portion for the “testing data.”
2. Using the training data, for each sense of each word, extract contextual features (e.g. record which words are found frequently occurring next to, or in the same sentence as, or within n words distance of the target word).
3. Determine common patterns in the contextual features (e.g. apply any standard machine learning algorithm, whether that be neural nets, or case-based reasoning, or genetic classifiers, or other) to enable classification among several senses of a word, and validate the classifier on the testing data.
   a. If the classifier performs well against the test data, then the project is finished;
   b. If the classifier initially does not perform well against the test data, then the classifier is tuned until it performs better against the test data. Such tuning could mean selecting different features from step 2 and/or adjusting the values (weights) of the various features against each other.

After the foregoing project is completed, then based on the determined patterns (or feature value-sets, or derived rules concerning them) of the classifier, new occurrences of words (given a surrounding context, i.e. the text before and/or after the word) can be assigned a guess, or a probability, of having certain senses, i.e. be classified according to their canonical sense. A considerable amount of research and debate has surrounded steps 2 and 3 of this process, and it is no doubt fruitful to investigate and optimize these phases. However, the conventional methods of word sense disambiguation proposed agree on Step 1. A large set of manually tagged training data is presumed in the vast majority of methods attempted in word sense disambiguation.

### SUMMARY OF THE INVENTION

The above described method and the required manually tagging of training data, by itself, presents the biggest limitation for search applications. In particular, the need to manually tag a corpus containing numerous example sentences for each word in a variety of contexts, presents not one, but several problems to the designer of an open-ended search application:
1. The manual labor cost, in number of hours, is mind-boggling. It can take a couple of graduate students an entire semester to manually tag the several thousand example sentences that are required as training data for disambiguating one single word in the English language as an example of their algorithm. For this effort to be extrapolated to the entire English language in common use (say, 200,000 words or more) is something difficult to imagine.
2. The labor in question is not just any sort of labor, but linguistically trained labor. The tagging must be performed by those who understand grammar, parts of speech and canonical word senses, and are very literate. This skill requirement extends far beyond that of the worker typically employed to do standard data processing. This fact further magnifies the prospective cost of manually tagging a corpus.
3. Many word senses simply do not have enough examples in the corpus to provide a sufficient baseline for subsequent disambiguation, even if the data were all tagged.
4. Some words have senses which have not yet entered the canonical sense listings.
5. Some words are new, and have not even been entered as headwords in standard lexicons.

Thus, there exists an unfulfilled need for a system and method that minimizes the limitations and disadvantages of the prior art system and methods for searching and retrieving electronic documents. In particular, there exists an unfulfilled need for a system and method that increases the number of relevant electronic documents that are missed in performing a search. In addition, there exists a need for such a system and method that reduces the inclusion of irrelevant electronic documents in results of a search. Moreover, there also exists an unfulfilled need for a system and method that provides more relevant electronic documents in response to a query than possible by simple keyword searching.

In view of the foregoing, an advantage of the present invention is in providing a system and method that reduces the number of relevant electronic documents that are missed in performing a search.

Another advantage of the present invention is in providing a system and method that reduces the inclusion of irrelevant electronic documents in results of a search.

Still another advantage of the present invention is in providing an economical system and method that provides more relevant electronic documents in response to a query than possible by simple keyword searching.

In accordance with one aspect of the present invention, a system for semantic search for electronic documents stored on a computer readable media, and providing a search result in response to a query, is provided. In one embodiment, the system comprises a corpus including a plurality of electronic documents that are tagged at a document level to identify general domain of each electronic document, and are analyzed based at least partially on the tags to identify word usage patterns in the plurality of electronic documents. The system also includes an index of word usage patterns that indexes the plurality of documents in the corpus according to word usage patterns and the domain tags of the plurality of electronic documents, and a query pre-processing module that receives a query from a user, and analyzes the query to determine probable word usage patterns in the query. The system further includes a processor that uses the index to identify at least one of the electronic documents having word usage patterns that matches the probable word usage patterns in the query as a candidate electronic document, and retrieves the candidate electronic document.

In accordance with another embodiment, the system further includes a post-processing module that analyzes the retrieved candidate electronic document to determine exactness of match between the probable word usage patterns of the query and word usage patterns of the candidate electronic document. The processor identifies a plurality of candidate electronic documents determined to have matching word usage patterns, and ranks the retrieved candidate electronic documents based on exactness of match to provide those candidate electronic documents with the highest ranking as a search result.

In accordance with another embodiment, the word usage patterns of the index are clustered based on similarity between the patterns. The system may be implemented so that the query pre-processing module is further adapted to disambiguate word sense in the query. In this regard, the query pre-processing module further elicits contextual information from a user, receives a selection of a word usage pattern or a set of synonyms from a user, and/or selects a ranked, probabilistic word usage pattern.

In accordance with another implementation, the post-processing module determines proximity of words of the query to each other in the candidate electronic document to determine exactness of match, so that the words of the query must be within a predetermined proximity range to each other within the electronic document in order for the electronic document to be provided as a search result. Different types of words of the query may be assigned different proximity ranges.

In still another embodiment, the post-processing module determines word order for words of the query in the candidate electronic document in determining exactness of match, and assigns a word placement score based on the determined word order match. The post-processing module reduces the word placement score a decreasing amount as the number of intervening words between words of the query in the candidate electronic document increases.

Moreover, in another embodiment, the query pre-processing module and/or post-processing module may be implemented to also select a topic and a sub-topic of a domain; recognize an ontological element of the query; select a synonym or a set of synonyms for a word in the query; determine interrogative type of the query; identify multiword terms in the query (e.g. “operating system” or “rock and roll”); identify a proper name in the query; correct spelling and grammar of a multiple word pattern in the query; and/or perform semantic analysis of common verbs and adjectives in the query. The system may further be implemented to provide paid search content together with a search result, where the paid search content is analyzed and provided together with the search result only if the paid search content is determined to have word usage patterns matching word usage patterns of the query.

In accordance with another embodiment, the query pre-processing module includes a user interface that is adapted to provide a first entry field to receive input of the query, and includes a second entry field to receive input of context clue words; provide to the user, a real-time cue as to which domains the system is construing the query to belong to; render the query in a first color, and change the first color to a second color when the query is disambiguated; and/or prompt the user to continue entering additional words related to the query to facilitate disambiguation thereof.

In accordance with yet another embodiment of the present invention, the system for semantic search for electronic documents includes a corpus of a plurality of electronic documents, a tagging module that tags the plurality of electronic documents in the corpus at a document level to identify general domain of each electronic document, a word usage module that determines word usage patterns in the plurality of electronic documents in the corpus based at least partially on the tags of the plurality of electronic documents, and an indexing module that indexes the plurality of electronic documents in the corpus at least according to word usage patterns and domain tags.

In accordance with another aspect of the present invention, a computer implemented method for semantic search for electronic documents stored on a computer readable media, and providing a search result in response to a query is provided. In one embodiment, the method includes providing a corpus including a plurality of electronic documents that are tagged at a document level to identify general domain of each electronic document, and are analyzed based at least partially on the tags to identify word usage patterns in the plurality of electronic documents. The method also includes providing an index of word usage patterns that indexes the plurality of electronic documents in the corpus according to word usage patterns and the domain tags of the plurality of electronic documents, receiving a query from a user, and analyzing the query to derive probable word usage patterns in the query. The method further includes using the index to identify at least one of the electronic documents that has word usage patterns matching the probable word usage patterns in the query as a candidate electronic document, and retrieving the candidate electronic document.

In yet another embodiment, the computer implemented method includes providing a corpus of a plurality of electronic documents, tagging the plurality of electronic documents in the corpus at a document level to identify general domain of each electronic document, determining word usage patterns in the plurality of electronic documents in the corpus based at least partially on the tags of the plurality of electronic documents, and generating an index of word usage patterns that indexes the plurality of documents in the corpus according to the word usage patterns and the domain tags of the plurality of electronic documents.

In accordance with still another aspect of the present invention, a computer readable medium with executable instructions is provided for implementing the above described system or method. In one embodiment, the computer readable medium includes instructions for receiving a query from a user, instructions for analyzing the query to derive probable word usage patterns in the query, and instructions for accessing an index of word usage patterns that indexes a plurality of electronic documents according to word usage patterns in the plurality of electronic documents, the plurality of electronic documents being tagged at a document level to identify general domain of each electronic document. The medium also includes instructions for identifying at least one of the electronic documents that has word usage patterns matching the probable word usage patterns in the query as a candidate electronic document, and instructions for retrieving the candidate electronic document.

In another embodiment, the computer readable medium includes instructions for accessing a corpus of a plurality of electronic documents, instructions for tagging the plurality of electronic documents in the corpus at a document level to identify general domain of each electronic document, instructions for determining word usage patterns in the plurality of electronic documents in the corpus based at least partially on the tags of the plurality of electronic documents, and instructions for generating an index of word usage patterns that indexes the plurality of documents in the corpus according to the word usage patterns and the domain tags of the plurality of electronic documents.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 shows a schematic view of a semantic search system in accordance with one embodiment of the present invention.

FIG. 2 shows example word usage patterns derived from sample electronic documents using the semantic search system of FIG. 1.

FIG. 3 is an example portion of the word usage pattern index.

FIG. 4 is a schematic flow diagram of a method in accordance with one embodiment of the present invention.

### DETAILED DESCRIPTION OF THE PREFERRED EMBODIMENT

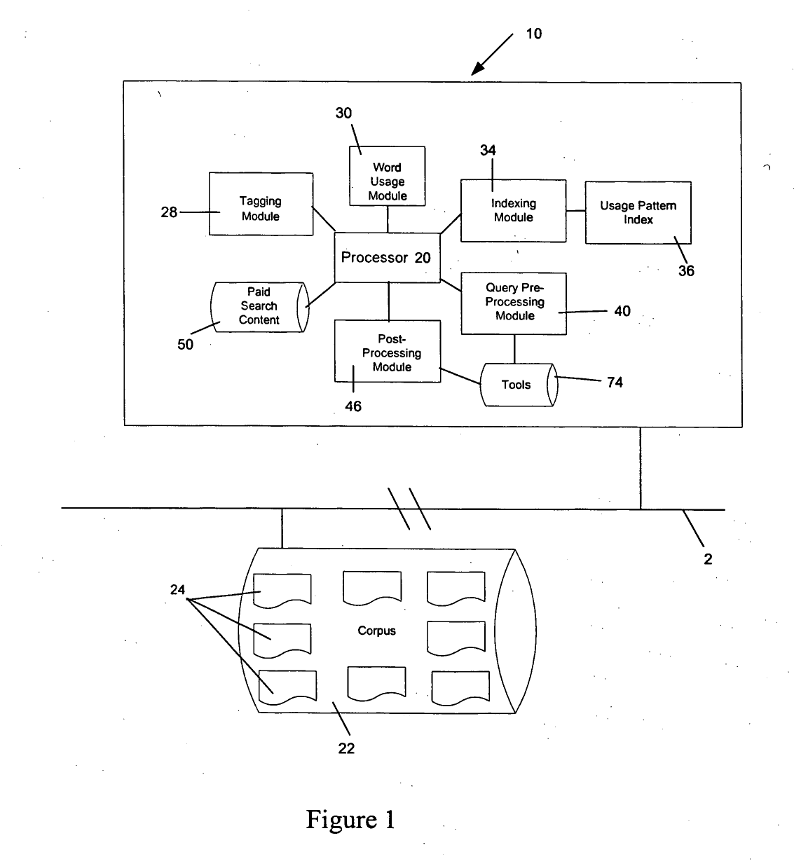

FIG. 1 illustrates a schematic view of a semantic search system 10 in accordance with one embodiment of the present invention for semantically searching for electronic documents stored in a computer readable media in response to a query, and providing a search result. The above noted advantages are attained by the semantic search system 10 of the present invention which utilizes a novel method involving analysis of word usage patterns that provide another dimension of linguistic analysis related to word senses.

It should initially be understood that the semantic search system 10 of FIG. 1 may be implemented with any type of hardware and/or software, and may be a pre-programmed general purpose computing device. For example, the semantic search system 10 may be implemented using a server, a personal computer, a portable computer, a thin client, or any suitable device or devices. The semantic search system 10 and/or components thereof may be a single device at a single location or multiple devices at a single, or multiple, locations that are connected together using any appropriate communication protocols over any communication medium such as electric cable, fiber optic cable, or in a wireless manner.

It should also be noted that the semantic search system 10 in accordance with the present invention is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the semantic search system 10, or divided into additional modules based on the particular function desired. Thus, the present invention, as schematically embodied in FIG. 1, should not be construed to limit the semantic search system 10 of the present invention, but merely be understood to illustrate one example implementation thereof.

Referring again to the illustrated embodiment of FIG. 1, the semantic search system 10 includes a processor 20 that is connected to a corpus 22 having a plurality of electronic documents 24. It should be evident that the corpus 22 illustrated is remotely located, and is in communication with the semantic search system 10, via a network such as the Internet 2. Of course, in other embodiments, the corpus 22 may be provided within the semantic search system 10 itself as a component thereof.

The semantic search system 10 also includes a tagging module 28 that tags the plurality of electronic documents 24 in the corpus 22 at a document level to identify general domain of each electronic document 24, the tags/domain indicating the general content or subject matter of the electronic documents. It should be understood that as used herein, the term “electronic document” refers to any computer readable file, regardless of format and/or length. For instance, web pages of websites, word processing documents, presentation documents, spreadsheet documents, PDF documents, etc., are all examples of electronic documents referred to herein.

In addition, the term “domain” used herein refers to a general topical area of related concerns which is distinct from other general topical areas of concern. Typically, domains have both enthusiasts and experts who are likewise distinct from the enthusiasts and experts of other areas of concern. A domain is characterized also by the fact that the sub-domains within it have in common, many of the most important types of entities, processes, and events that are either absent, or are far less important, in other domains. In other words, a domain's sub-domains are more specific categories within that domain, where the most important types of entities and events nonetheless cross over, as well as many of the enthusiasts and experts.

Consider, for example, the domain of Sports. Many of the enthusiasts and experts in one sport are also enthusiasts or experts in another sport, e.g. many collegiate coaches can coach more than one sport; many athletes can play more than one sport very well. The most important types of entities and events in a particular sport are often “players, “agents”, “coaches”, teams”, “games,” “the college draft”, and despite that we switch our attention to a different sport, (e.g. from football to basketball), the fact remains that these important entities are still the most important entities and events within the Sports domain. Meanwhile, in other domains, say, Finance, these Sports-related entities and events do not exist at all (or exist only rarely); nor does expertise in (or enthusiasm for) football translate usually into that person being an expert or enthusiast in Finance. All of this tells us that all of Sports in general, including the various specific sports, constitutes a single domain, quite distinct from the domain of Finance.

In accordance with the illustrated embodiment of the semantic search system 10, a word usage module 30 is provided that determines word usage patterns present in the plurality of electronic documents 24 of the corpus 22. This determination of word usage patterns is preferably based at least partially on the tags of the electronic documents discussed above which give clues or guidance as to how a word is being used for disambiguation purposes. The word usage module 30 is also preferably adapted to group the word usage patterns based on similarity between the patterns.

The term “word usage pattern” as used herein refers to the pattern or structure of the contextual information present when the word is used, or groupings (clusters) of similar patterns. Generally, within and among all the frequently occurring contextual information associated with the use of a particular word, there normally are certain items that can be found more frequently together. Contextual information refers to the sum total of language use and the situations in which the particular word is used, e.g. the grammar, the semantics (including word senses, synonyms, hypernyms, hyponyms, antonyms, holonymns, meronyms, etc.), the history of the discourse (what was said previously), the domain of discussion where the word is found, the identity and background information of both the speaker (or writer) and the audience, the location, setting and environment of the writing or speaking, the time of the utterance and its relative placement within the millennia, the century, the year, the month, the week, and/or the day, etc.

Consider, for example, the word “gay” which in documents previous to 1960 was frequently associated with concepts or words such as “carefree” and “light-hearted”, and in documents after 1980 is seldom associated that way, but instead more often with “homosexual” and “lesbian”; and in documents between 1960 and 1980 these two different patterns of association are rather more mixed. Another example is that the word “football” in documents with an American origin will more often be connected with “NFL” whereas in documents originating anywhere else in the world, this association is far less common. Still another example is that that the word “take” when it is part of the phrase “take a break”, is often used in the context of “working” (and synonyms of working) and “tired” (and synonyms thereof). Yet another example is that the phrase “collateral damage” is most often used in documents authored by government officials, whereas “civilian casualties” is more often found in news articles written by journalists.

Thus, contextual information is provided in a pattern or with a structure when the particular word is used. Of course, any one of these examples of patterns in word occurrences, taken by itself, is not a complete/total word usage pattern for the particular word. However, upon obtaining information regarding numerous different word occurrences for a particular word, the total of all such information can be organized into related groups that set forth the various usage patterns associated with a particular word.

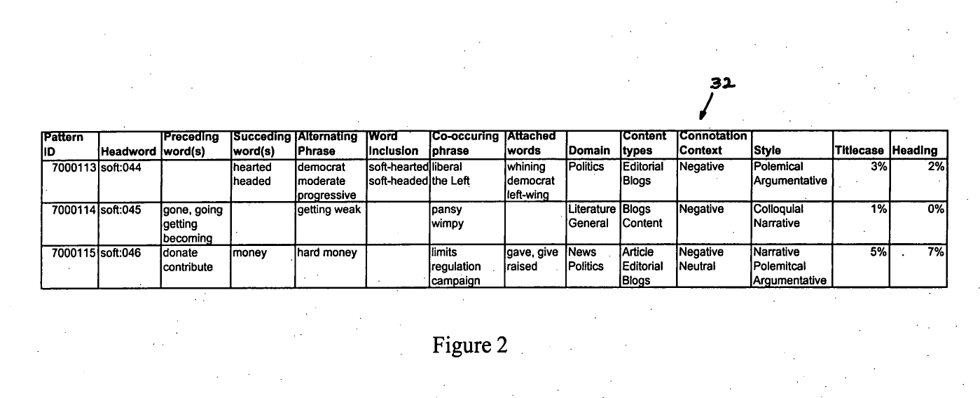

In the above regard, FIG. 2 shows table 32 with example word usage patterns derived from sample electronic documents. Each row signifies a word usage pattern as determined by the word usage module 30 in accordance with the present invention, the various columns setting forth the various information or aspects of a particular usage pattern. Thus, the Pattern ID 7000113 sets forth the usage pattern for the word “bleeding” as used in the phrase “bleeding hearted liberal” within a document related to the domain of Politics. Correspondingly, the usage pattern ID 7000113 notes that the words “hearted” or “headed” may succeed the word “bleeding”. This word usage pattern also notes presence of alternating phrases such as “democrat”, “moderate”, and “progressive”, and co-occurring phrases such as “liberal” and “the left”. Moreover, the domain of the usage pattern ID 7000113 is obtained from the above noted tag of the domain by the tagging module 28. As shown, various other aspects of the particular word usage pattern is set forth in the row corresponding to Pattern ID 7000113.

As also shown, various other usage patterns for the word “bleeding” are set forth in the remaining rows of the table 32. Of course, these three examples do not represent a complete set of usage patterns for the word “bleeding”, but are merely provided as examples of how a word usage pattern can be generated by the word usage module 30 from an electronic document that is analyzed. As additional electronic documents 24 of the corpus 22 are analyzed by the word usage module 30, additional word usage patterns can be generated for the same word, as well as for other words of the electronic documents.

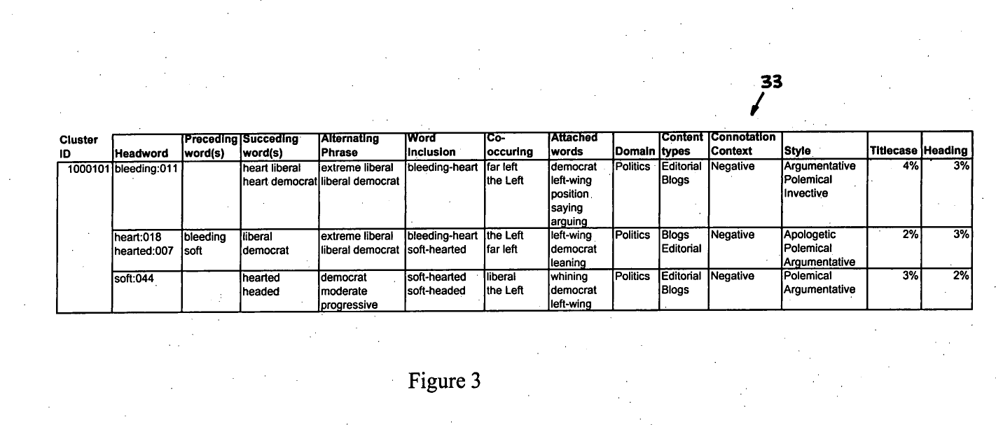

As noted above, these word usage patterns can then be organized into related groups or clusters that set forth the various usage patterns associated with a particular word. In this regard, table 33 of FIG. 3 shows such a grouping or clustering of word usage patterns of the word “bleeding”. As shown, Cluster ID 1000101 sets forth word usage patterns as determined from the analysis of a plurality of electronic documents by the word usage module 30. Thus, as noted, the term word usage patterns as used herein should be understood to encompass such groupings or clusters of word usage patterns as well.

It should also be noted that the word usage module 30 may be implemented to converge word usage patterns together. For example, upon analyzing numerous electronic documents, the word usage module 30 may find that a usage pattern of the word “pigskin” overlaps to a great degree with one or more usage patterns for the word “football”. The word usage module 30 may be implemented to link the two words together in such an instance. In other words, in certain cases where “football” is used to denote the ball itself that is utilized in American football, it will have a certain usage pattern such as frequently being attached to the verb “kick” and to the adjective “slippery,” etc. Because “pigskin” will be found to have much the same attachments to “kick” and to “slippery,” etc. in the same kinds of documents and in the same domain and by some of the same authors, etc., the word usage module 30 can conclude that the usage patterns are related to one another and converge the matching word usage patterns together.

Of course, there are other usage patterns of the word “football” that are not related at all to the word “pigskin”, such as usage patterns derived from documents pertaining to European Football or “Soccer.” Thus, it should be evident from the above that word usage patterns that are determined by the word usage module 30 of the present invention are valuable not just for distinguishing the various uses of a word to ensure one usage matches the word sense of another, but that the usage patterns are also valuable in identifying in which cases a word may be roughly synonymous with another, given its surrounding context.

It should also be understood that that the general observation that words have varying usage patterns is widely accepted among those in the art of artificial intelligence, and that there exist numerous alternative methods of extracting, detecting, and comparing word usage patterns. The particular method of determining word usage patterns as described above is not the only method that could be employed to implantation of the semantic search system 10 of the present invention. Instead, other methods of determining word usage patterns could be readily employed in other embodiments.

Referring again to FIG. 1, an indexing module 34 is also provided in the semantic search system 10 that indexes the plurality of electronic documents 24 in the corpus 22 according to the word usage patterns as determined by the word usage module 30. Correspondingly, the indexing module 34 generates a word usage pattern index 36 that has indexed entries of a plurality of word usage patterns or clusters of such patterns as shown in table 33 of FIG. 3. The generated word usage pattern index 30, or entries thereof, are mapped to various document ID's. Such mapping of the word usage pattern index 36 to document ID's may be implemented using any appropriate mapping methods and systems, the details of which being omitted herein since they are known in the art.

The semantic search system 10 is further provided with a query pre-processing module 40, as shown in FIG. 1, that receives a query from a user which serves as a basis for searching and retrieving electronic documents from the corpus 22 that are relevant to the query. In contrast to the conventional search systems where a keyword search is performed on the words of the query, the query pre-processing module 40 of the present invention analyzes the received query to determine probable word usage patterns in the query as discussed in further detail below. In addition, the illustrated preferred embodiment of the query pre-processing module 40 also functions to determine the domain of the query so that identification and retrieval of relevant electronic documents can be ensured. In this regard, various features may be provided in database 74 to facilitate determination of the probable word usage patterns, domain and/or intended word senses of the query as described in further detail below.

The processor 20 of the semantic search system 10 refers to the word usage pattern index 36 shown in FIG. 2 to find word usage patterns that matches the determined probable word usage patterns of the query. The processor 20 then uses the word usage pattern index 36 to identify as candidate electronic documents, those electronic documents indexed under the matching word usage patterns. This differs markedly from conventional systems and methods proposed that utilize a keyword-based index of the electronic documents rather than an index of their word usage patterns. Thus, those electronic documents indexed by the indexing module 34 that have the word usage patterns matching the probable word usage patterns of the query are identified as candidate electronic documents. These candidate electronic documents are retrieved by the semantic search system 10 for further analysis as described in further detail below.

Referring again to FIG. 1, the semantic search system 10 further includes a post-processing module 46 that analyzes the retrieved candidate electronic documents to determine exactness of the match between the probable word usage patterns of the query as determined by the query pre-processing module 40, and the word usage patterns of the candidate electronic documents that were identified and retrieved by the processor 20. At this juncture, the post-processor has a substantial advantage over conventional semantic post-processors that are designed to operate with keyword-based search engines, in that the candidate results that are provided to the post-processing module 46 are already index according to which word usage patterns they have been found to instantiate. This results in a significant advantage and head start in validating a contextual semantic match between the words of the electronic documents and the words of the original query. The post-processing module 46 of the illustrated embodiment also ranks the retrieved candidate electronic documents based on exactness of match as further detailed below, and provides those candidate electronic documents with the highest rankings as a search result.

Moreover, in the illustrated embodiment of FIG. 1, the processor 20 is further adapted to provide paid search content from database 50, together with the query result. Various methods of incorporating paid search content may be used. However, the semantic search system 10 of the present invention allows the paid search content to be generated only in those instances where it is relevant to the search query. This is made possible because the domain, and the word sense or word usage pattern of the search query, the corpus, and/or the advertisement itself, are known to a higher level of accuracy than possible with conventional systems and methods. For example, both a metallurgist and a maker of PDA devices could win the highest ranked advertising slot for the word “tungsten,” but with their corresponding ads being displayed correctly, i.e. when the word is used in the sense of raw materials versus the name of the popular Palm® handheld device. This is a substantial improvement over the conventional paid search systems that require these two advertisers to bid against each other to determine whose ad will appear in the top slot in every instance of the word “tungsten”, regardless of context.

The above description of the semantic search system 10 as shown in FIGS. 1 to 3 provides a general overview of its various modules and functions of the present invention. The discussions herein below set forth additional details regarding additional features of the various modules in accordance with embodiments of the present invention, and/or further describe their differences relative to the conventional search systems and methods.

Tagging Module

In the illustrated preferred embodiment of FIG. 1, the tagging module 28 tags the plurality of electronic documents 24 in the corpus 22 essentially only at a document level. This provides particular advantages over the conventional systems and methods proposed because tagging only at the document level, instead of at the word sense level as suggested in the conventional systems and methods, provides a critical savings in labor. The savings realized is so significant that it makes the difference between the project being feasible, and not being feasible, within any realistic limitations of time and cost.

Preferably, the semantic search system 10 of the present invention utilizes document-level tagging and the topical domain of each electronic document as clues in determining word usage patterns in the electronic document during analysis thereof by the post-processing module. Since there are already numerous document indexes on the World Wide Web, including Yahoo®, Google®, and others, there exists a good deal of information already on the topical domain for the available electronic documents. Also, major publishers such as the New York Times®, About.com, etc. also provide some kind of topical taxonomy which can be used to provide the topical domain information for the electronic documents. Of course, the various publishers do not use the same taxonomy. Nonetheless, their topic labels are time-saving clues for properly tagging documents.

Alternatively, in other implementations, some document classifiers, of which there are numerous commercially available, could be used to automatically classify documents into a single topic taxonomy, once sufficient examples have been classified, for example, by manual classification. These classifiers use the above described conventional procedure of tagging, feature extraction, train-and-test that was previously explained, but on much more macroscopic (rather than microscopic) view of documents, thereby making such procedure much more feasible with regards to the labor that is required. In other words, it is not very difficult to set up training data for a document classifier, as compared to what is involved in doing so for a word-sense classifier that is suggested in the art.

Of course, in other embodiments, the tagging module 28 may also optionally be used to perform other tagging functions as well, for example, to tag word senses of individual words as suggested by the conventional systems and methods. However, this is not desirable since tagging of all of the individual words of a document would result in various disadvantages discussed above.

Indexing Module

Prior art keyword search engines revolve around an index of words whereas the preferred embodiment of the semantic search system 10 in accordance with the present invention does not. Instead, the semantic search system 10 of the present invention performs the search using the generated word usage pattern index 36 composed of the ID's of word usage patterns that are associated to document ID's, thereby providing a tremendous speed savings, as the accessing of variant senses of a word is performed substantially together with the search itself, rather than being done as an after-thought.

Of course, the indexing module 34 may also be implemented to index the plurality of electronic documents 24 in the corpus 22 according to canonical sense numbers to further increase search criteria available for use in improving relevancy of the electronic documents provided as search results. However, such indexing based on word senses have various disadvantages previously discussed.

Query Pre-Processing Module

As discussed above, the query pre-processing module 40 receives the user query, and analyzes the query to determine the probable usage pattern in the query. The user's query is characterized as pointing, either discretely or probabilistically, at certain semantic concepts to derive word usage. Once the probable word usage patterns of the query are determined, the semantic search system 10 of the present invention searches for, and retrieves, electronic documents from the corpus 22 that satisfy the query by referring to the word usage pattern index 36 as previously described.

It should be understood that accurate word usage pattern information cannot always be extracted from the query. Whereas the above analysis by the query pre-processing module 40 is likely to be useful, it may only be partly successful, for the simple reason that the query is shorter than an entire document (or substantial portions thereof). Word usage pattern may not be clear in such short text since minimal contextual information is provided. Moreover, whereas the electronic documents typically have domain information associated thereto that provides some clues as to the subject matter and content of the documents so that analysis of word usage patterns can be enhanced based on such information, user queries frequently do not have such domain information associated thereto. In such an instance, additional information is desirable in order to determine at least the domain of the query so that relevant electronic documents can be identified and retrieved as the search result. Nonetheless, when there are contextual words in the query itself that fit word usage patterns, predictive information can be extracted by the pre-processor module to analyze the query, and to determine probable word usage patterns in the query.

In consideration of the above limitations, the query pre-processing module 44 of the semantic search system 10 is preferably implemented to also disambiguate the query to identify the general domain of the query. Domain disambiguation is valuable for identifying and providing relevant query results, and is an easier task, compared to determining word senses of the query and determining the domain of the query based on the word senses. People normally do not equivocate between different meanings of the same word within the same topic or subject matter. This stands to reason, since it would be difficult to communicate otherwise. Therefore, performing domain identification, if possible, provides one of the strongest clues as to which sense of word is intended in the query, without starting the analysis looking at word senses which is very difficult to actually implement.

In particular, because domain disambiguation is broader and more general than “dissecting” each word in a query for word sense, there is reason to conclude it is an inherently easier task, and therefore, a prudent place to begin analysis. This fact is illustrated anecdotally by examining the domain classifications in different canonical word senses in established lexicons, and merely noting that there are typically several senses which are assigned to different domains, with several word senses that are assigned to no domain at all. This means that there are several judgments to be made in determining word senses across a query.

In contrast, there is only one judgment to be made in determining a typical query's domain. These facts alone indicate that the domain identification of the words of the query should be easier than trying to perform word sense disambiguation of each word of the query directly, since the domain identification requires fewer judgments (i.e., one, rather than several). Furthermore, there is an asymmetry in mapping from domains to words in that a single domain will generally utilize a single sense for a particular word, whereas a single word will typically indicate several candidate domains. Correspondingly, it is more fruitful to approach word sense disambiguation, if required, after having already determined the domain of the word, rather than to proceed with word sense disambiguation first to determine the domain of the word.

In the above regard, various additional tools or features may be provided in database 74 of the semantic search system 10 for increasing the likelihood that the query pre-processing module 40 analyzes the words of the query properly for the word usage patterns and/or domain. For instance, the query pre-processing module 40 may be implemented to utilize tools of database 74 to select a topic and sub-topic within a domain of the query, recognize an ontological element of the query, select a synonym or a set of synonyms for one or more words of the query, determine interrogative type of the query (is it a where-question, a who-question, a how-question, etc.), and/or identify a multiword term in the query. The query pre-processing module 40 may further be implemented to utilize tools of database 74 to identify a proper name in the query, correct spelling and grammar of a multiple word pattern in the query, and/or perform semantic analysis of common verbs and adjectives in the query.

Such tools including an HTML parser, word frequency analyzer, proper name identifier, word usage profiler, semantic resemblance measures, and so on, are available in industry. For example, there are numerous proper name identification modules available in the industry, and it would not matter greatly which one was to be used. The same could be said for HTML parser and other lower-level modules/tools. The query pre-processing module 40 is preferably implemented so that it can invoke such tools/features from the tools database 74 which provides recognition of ontological distinctions in texts. These distinctions can, in turn, be used to provide clues as to whether the following concepts exist in the query: a Person, Place, Thing, Idea, Event, Action, Process, Manner, Quality, Quantity, Relation, Space, Time, Cause, Reason, Matter, Form. Thus, these features/tools can be used by the query pre-processing module 40 to enhance accuracy of the analysis of the query. For example, the semantic search system 10 can be implemented to determine that:
“What are the different materials golf clubs are made of?” is a Matter query;
“Who was the US Secretary of Defense in 1971” is a Person question;
“When will the next Solar Eclipse occur” is a Time question, etc.

It is always possible that any retained ambiguity within the query will become inconsequential upon searching for the relevant electronic documents because certain combinations of sense of different query words will not appear together in the search space. For example, consider “Bank of Williams” and that the semantic search system 10 in accordance with the present invention eliminates sense 3 (turning an aircraft) and sense 4 (ricocheting projectile), but leaves open senses 1 and 2 (financial institution and edge of river). Now suppose that in the world (and in the search space) there is a river called the “Williams” and there does not exist any financial institution named “Williams”, or conversely, suppose there is a “Williams Savings and Loan” but there does not exist any river called “Williams.” In either of these cases, despite the ambiguity, the correct items are likely to be found and presented at the top of the search results by the system of the present invention. However, in the case where there is both a river and a bank named “Williams”, there is simply not enough information in the query for a human being, let alone an automated search application, to determine the proper sense of the word. In such a case, the system must either present search results based on mixed senses (i.e., must mix both kinds of electronic documents in the search results), use some additional information to determine the word sense for the words of the query, or must prompt the user for a resolution.

In consideration of such instances where resolution by the user may be required, the query pre-processing module 40 is preferably implemented with a user interface adapted to facilitate entry of the query by the user, while enhancing the likelihood of the proper analysis of the query by the query pre-processing module 44. Although different implementations of the user interface may be provided in various embodiments, the embodiments disclosed below provide effective interfaces for such instances.

In one embodiment, the user interface may be implemented with a first entry field for receiving input of the query, and a second entry field for receiving input of context clue words. The context clue words are preferably not directly analyzed for word usage patterns like the words of the query, but instead, are merely used to clarify any ambiguity in the words of the query, for example, to allow determination of the appropriate domain if two potential domains still exist after analysis of the word usage pattern of the query.

In another implementation, the user interface may be adapted to provide to the user, a real-time cue as to which domains the system is construing the query to belong to, for example, as the user types the query. For instance, the user interface may be implemented to show progressive results, with a time-sequenced display in javascript of the domains, and optionally, clusters of usage patterns, that are constraining the search. For example, when the user submits the query, a confirmation can be displayed stating “Searching in [domain name] . . . for [cluster members].” This type of confirmation would help to gradually educate the user, in an unobtrusive manner, as to the greater depth which the user can, and should bring to the query submission process. Such a user interface effectively shows the user where, and over what sort of content, the semantic search system 10 is searching, thereby make waiting for search results more tolerable.

In still another implementation, the user interface of the query pre-processing module 40 may be implemented to render the words of the query in a first color, and to change the first color to a second color as each word of the query is disambiguated. For instance, the ambiguous words may be rendered in red color, words that are just somewhat ambiguous in yellow, and words that have been disambiguated in green. Thus, as the user types more words into the query, the contextual information added thereby has the effect of turning more words from red to yellow to green, as disambiguation occurs.

The user interface of the query pre-processing module 40 may also be implemented so that contextual information is elicited directly from the user of the system for resolution and/or clarification if preliminary analysis of the words of the query indicates that the query stills contain significant ambiguity. For instance, in the above example implementation, the user can be prompted upon entering a query to “Please keep typing” until the words are all green or yellow, with no red. Of course, a similar affect can be attained by textually prompting the user to continue entering additional words related to the query to facilitate disambiguation thereof. In still another embodiment, the query pre-processing module 40 may be implemented to display a word usage pattern or a set of synonyms to the user, and requesting the user to select the most relevant word usage pattern or synonyms from those presented. In yet another alternative embodiment, the word usage patterns may be provided to the user, ranked in the order of probability or popularity, and the user requested to select an appropriate word usage pattern.

One significant advantage of the semantic search system 10 in accordance with the present invention is that because it preferably conducts searches based primarily on word usage patterns instead of keywords or canonized word senses, the present invention disambiguates non-canonical senses of words as well. In particular, by determining and using usage patterns of words, the present invention allows the inclusion of distinctive senses of a word not yet included in canonical sources, by the virtue of these senses having a unique word usage pattern. Referring again to the above discussed example, the word “bleeding” as used in the phrase “bleeding heart liberal”. Suppose that “bleeding heart liberal” is not yet available as a headword entry in the canonical sources, and that the domain-based, document-level tagging has been accomplished, e.g. that each document is marked as to whether it is in the domain of Finance, Sports, Entertainment, etc. Putting these elements together, the semantic search system 10 functions to find that frequently within documents classified in the domain “Politics,” the word “bleeding” frequently occurs to the left of “heart liberal” and in the presence of certain pejorative terms, and in the presence of certain polemical language. This constitutes a distinctive word usage pattern, and as such, is created as an indexed entry, despite that there is technically no “sense” of the word “bleeding” that has been established canonically in the English lexicon for this sense.

Post-Processing Module

As noted, the post-processing module 46 of the semantic search system 10 analyzes the candidate electronic documents that were identified and retrieved by the processor 20, to determine exactness of match between the probable word usage patterns of the query, and word usage patterns of the candidate electronic documents. In this regard, the analysis discussed above with respect to the query module can also be performed by the post-processing module 46 on the retrieved candidate documents, or portions thereof to determine the exactness of match.

In addition, the post-processing module 46 is preferably implemented so that the above discussed various tools and features from database 74 can be utilized in a similar manner, to enhance analysis of the plurality of documents that have been retrieved as candidate electronic documents to determine exactness of match. In particular, the post-processing module 46 may be implemented to recognize an ontological element in the candidate electronic documents, select a synonym or a set of synonyms in the candidate electronic documents, identify a multiword term in the candidate electronic documents, identify a proper name in the candidate electronic documents, correct spelling and grammar of a multiple word pattern in the candidate electronic documents, and/or perform semantic analysis of common verbs and adjectives in the candidate electronic documents.

In the illustrated embodiment, the post-processing module 46 of the semantic search system 10 is also preferably implemented to determine the proximity of words of the query to each other in the candidate electronic document to determine exactness of match. It is more desirable to have the query words found in close relation to one another in the candidate electronic document, rather than very far removed from each other, which indicates that the candidate electronic document may not be very relevant to the query, and should not be provided as a search result. Thus, the post-processing module 46 is further implemented in the illustrated embodiment to require the words of the query to be within a predetermined proximity range to each other within the electronic document in order for the electronic document to be provided as a search result by the semantic search system 10.

Preferably, on analyzing of the proximity of words, the post-processing module 46 is implemented to employ two or three different sized zones of proximity, for different types of words. For example, a prepositional phrase may be required to be found in closer in proximity to its object, or in special patterns, in order to count as being within the required proximity range. However, actor words can be rather distant from their action and their object, when there are numerous qualifying phrases between them concerning the time, manner, and place of the action. Thus, in the manner described, different types of words of the query are assigned different proximity ranges by the post-processing module 46.

In addition, in accordance with the illustrated embodiment, the word order in the candidate electronic documents is utilized by the post-processing module 46 in determining the exactness of the match. In the above regard, the post-processing module 46 assigns a word placement score corresponding to the determined word order match, or lack thereof. One particularly powerful way of utilizing word order is by performing a fuzzy conjugation check which is analogous to a fuzzy string match, but with each character representing a word. For example, the sentence “James sold a chair at the auction” would be found to have a strong fuzzy word order match to “James had a chair that was sold at the auction.” This allows the semantic search system 10 to count function words (e.g. “a”, “the”, etc.) as having importance in certain contexts, rather than their being discarded as in most conventional search engines.

Presence of gaps or intervening words between the words properly ordered in the portion of the document must be identified and addressed. For example, if the query is “nightgown that buttons all the way down” and the semantic search system 10 finds “nightgown,” then 30 intervening words, then “buttons all the way down,” it needs to count as a rather high fuzzy word placement score. This can be accounted for by identifying a set of begin-and-end points in a paragraph that have all the primary query words, and analyzing this stretch of words with fuzzy conjugation for comparison against the query. Correspondingly, the post-processing module 46 is further implemented in the present embodiment to reduce the word placement score as number of intervening words increases. Preferably, the amount that the word placement score is reduced is preferably progressively decreased, for example, by using a decay factor.

Paid Search Content

In the illustrated embodiment of FIG. 1, the processor 20 may optionally be further adapted to provide paid search content from database 50, together with the query result. Search engine marketing can be implemented in the semantic search system 10 of the present invention on at least three levels: (1) analysis of the input query for a concept; (2) analysis of the corpora; and/or (3) analysis of the advertiser's advertisement document. The ability to infer actual word sense or usages is clearly a benefit at all three levels in that instead of paying for an advertising based on a word, regardless of which sense it is used in, the advertiser can pay, and have their ads be shown, only in those instances where it is relevant to the search query. In this regard, in the preferred embodiment, the paid search content may be analyzed and provided together with the query result only if the paid search content is determined to have word usage patterns matching word usage patterns of the query.

Thus, as discussed in detail above, the semantic search system 10 of the present invention can dynamically create paradigmatic patterns associated with different usages of a word, without need for manual tagging required in the conventional systems and methods proposed in the art which are based on canonized senses of words. In the preferred embodiment, the semantic search system 10 generates a dynamic group of word usage patterns for each word or phrase. The present invention is fundamentally different than the conventional systems and methods proposed in that, rather than starting with senses, and analyzing a text corpus in view of these sense as suggested in the art, the semantic search system 10 and method of the present invention starts with a corpus, and devises usage groupings based on the distribution of linguistic features in the corpus, i.e. word usage patterns.

The present invention is advantageous over the convention search systems and methods proposed in that by being based on word usage patterns, the semantic search system 10 can provide relevant search results including all the extant usages of the word and is not limited to canonical senses. Thus, the system of the present invention can be utilized to form the basis of a completely new paradigm in search. In particular, the semantic search system 10 and method of the present invention is not constrained to the canonical senses, as are most systems and methods proposed in the art which are word sense disambiguation based. This is an important advantage in that canonized listings of word senses are notoriously incomplete with respect to every day usage of words. The system of the present invention can discover and recognize potentially every distinguishable sense of a word, instead of being limited to those that are canonical.

Moreover, the system can rapidly recognize new linguistic developments, and in some cases, even idiolectical usages (i.e. those of someone's idiosyncratic dialect, e.g. a novel or improvisational word or word usage found only on a single person's website), before they have become canonical. For instance, consider the first time someone ever used the word “infotainment.” Correspondingly, the semantic search system 10 of the present invention will not be required to leave significant segments of the text corpus semantically unmapped, as will any method that is limited to canonical sense. Instead, the system of the present invention can semantically map every word or phrase in the corpus given enough examples.

Of course, the above described preferred embodiment of the semantic search system 10 can be modified or implemented differently in other embodiments. In this regard, the present invention can be implemented to perform searches faster with simpler input required on the part of the user. In particular, the system and method of the present invention can be implemented to perform a keyword search first in response to the query. If a very strongly match for certain words of the query is not found, the system may be implemented to analyze the query using sets of synonyms or word usage patterns as described above for such words. Of course, this would require a separate keyword index that is parallel with the above described usage pattern index. Across many searches, this would provide a quicker average response time.

Another alternative implementation for real-time speed is to use usage pattern analysis in accordance with the present invention only to post-process the electronic documents that have been identified and retrieved based on traditional keyword type search. This would provide an even greater boost in speed, but at the expense of less accuracy and precision, although still being more accurate and precise than a keyword search by itself.

Furthermore, although the above embodiment of the present invention was described as deriving the usage pattern index, it should also be appreciated that in other embodiments a corpus may be provided which already includes a plurality of electronic documents that are tagged at a document level to identify general domain of each electronic document, and have been analyzed based at least partially on the tags to identify word usage patterns in the plurality of electronic documents. Moreover, an index of word usage patterns that indexes the plurality of documents in the corpus according to word usage patterns may also be already provided. Thus, the semantic search system in accordance with such an implementation includes a query pre-processing module that receives a query from a user, and analyzes the query to determine probable word usage patterns in the query, and a processor that uses the index to identify and retrieve at least one of the electronic documents having word usage patterns that matches the probable word usage patterns in the query as a candidate electronic document.

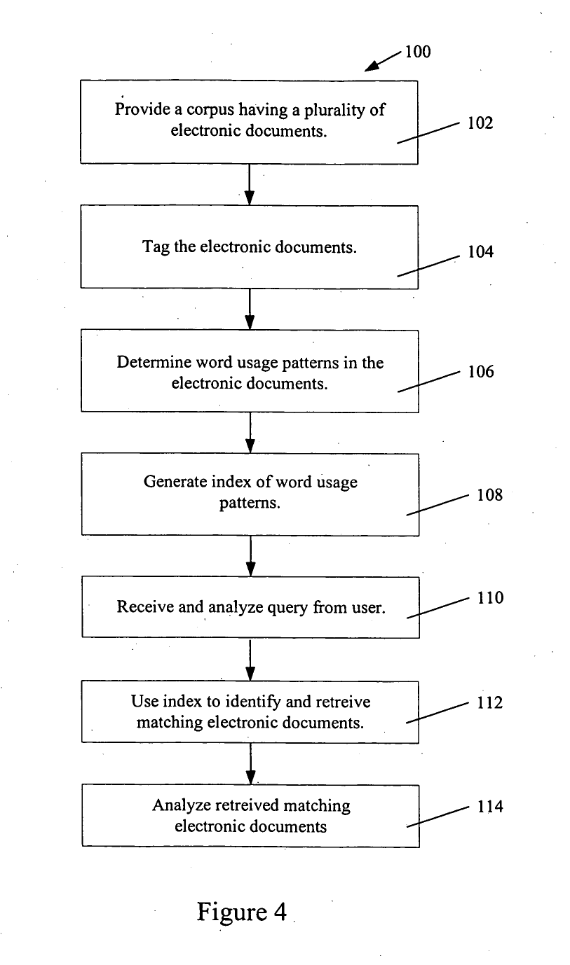

As also previously noted, another aspect of the present invention is a computer implemented method is provided for semantic search for electronic documents stored on a computer readable media, and providing a search result in response to a query. FIG. 4 shows a schematic flow diagram 100 that illustrates a method in accordance with one embodiment. As shown, the method includes providing a corpus of a plurality of electronic documents in step 102, and tagging the plurality of electronic documents in the corpus at a document level to identify general domain of each electronic document in step 104. The illustrated method also includes determining word usage patterns in the plurality of electronic documents in the corpus based at least partially on the tags of the plurality of electronic documents in step 106, and generating an index of word usage patterns that indexes the plurality of documents in the corpus according to word usage patterns in step 108.

In step 110, a query is received from the user and analyzed to derive probable word usage patterns in the query. In step 112, the generated index is used to identify and retrieve the electronic documents that have word usage patterns matching the probable word usage patterns in the query as candidate electronic documents. In step 114, the retrieved candidate electronic documents are analyzed to determine exactness of match between the probable word usage patterns of the query and word usage patterns of the candidate electronic documents.

In yet another implementation, the method includes providing a corpus including a plurality of electronic documents that are tagged at a document level to identify general domain of each electronic document, and are analyzed based at least partially on the tags to identify word usage patterns in the plurality of electronic documents. An index of word usage patterns that indexes the plurality of electronic documents in the corpus according to word usage patterns is also provided. In accordance with the present embodiment, the method includes receiving a query from a user, analyzing the query to derive probable word usage patterns in the query, using the index to identify the electronic documents that have word usage patterns matching the probable word usage patterns in the query as candidate electronic documents, and retrieving the candidate electronic documents.

Furthermore, in accordance with still another aspect, the present invention is embodied as a computer software program. In this regard, a computer readable medium with executable instructions is provided for implementing the above described system or method.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

I/We claim:

1. A system for semantic search for electronic documents stored on a computer readable media, and providing a search result in response to a query, comprising:
a corpus including a plurality of electronic documents that are tagged at a document level to identify general domain of each electronic document, and are analyzed based at least partially on said tags to identify word usage patterns in said plurality of electronic documents;
an index of word usage patterns that indexes said plurality of documents in said corpus according to word usage patterns and said domain tags of said plurality of electronic documents;
a query pre-processing module that receives a query from a user, and analyzes said query to determine probable word usage patterns in said query; and
a processor that uses said index to identify at least one of said electronic documents having word usage patterns that matches said probable word usage patterns in said query as a candidate electronic document, and retrieves said candidate electronic document.

2. The system of claim 1, further including a post-processing module that analyzes said retrieved candidate electronic document to determine exactness of match between said probable word usage patterns of said query and word usage patterns of said candidate electronic document.

3. The system of claim 2, wherein said processor identifies a plurality of candidate electronic documents determined to have matching word usage patterns.

4. The system of claim 3, wherein said processor ranks said retrieved candidate electronic documents based on exactness of match, and provides candidate electronic documents with the highest ranking as a search result.

5. The system of claim 1, wherein said word usage patterns of said index are clustered based on similarity between said patterns.

6. The system of claim 1, wherein said query pre-processing module is further adapted to disambiguate word sense in said query.

7. The system of claim 6, wherein said query pre-processing module further at least one of elicits contextual information from a user, receives a selection of a word usage pattern or a set of synonyms from a user, and selects a ranked, probabilistic word usage pattern.

8. The system of claim 6, wherein said query pre-processing module further at least one of:
selects a topic and a sub-topic within a domain of said query;
recognizes an ontological element of said query;
select a synonym or a set of synonyms for at least one word in said query;
determines interrogative type of said query;
identifies a multiword term in said query;
identifies a proper name in said query;
corrects spelling and grammar of a multiple word pattern in said query; and
performs semantic analysis of common verbs and adjectives in said query.

9. The system of claim 2, wherein said post-processing module determines proximity of words of said query to each other in said candidate electronic document to determine exactness of match.

10. The system of claim 9, wherein said words of said query must be within a predetermined proximity range to each other within said electronic document in order for said electronic document to be provided as a search result.

11. The system of claim 10, wherein different types of words of said query are assigned different proximity ranges.

12. The system of claim 2, wherein said post-processing module determines word order for words of said query in said candidate electronic document in determining exactness of match.

13. The system of claim 12, wherein said post-processing module assigns a word placement score based on said determined word order match.

14. The system of claim 13, wherein said post-processing module reduces said word placement score a decreasing amount as number of intervening words between words of said query in said candidate electronic document increases.

15. The system of claim 2, wherein said post-processing module further at least one of:
recognizes an ontological element in said candidate electronic document;
selects a synonym or a set of synonyms in said candidate electronic document;
identifies a multiword term in said candidate electronic document;
identifies a proper name in said candidate electronic document;
corrects spelling and grammar of a multiple word pattern in said candidate electronic document; and
performs semantic analysis of common verbs and adjectives in said candidate electronic document.

16. The system of claim 1, wherein said processor is further adapted to provide paid search content together with a search result.

17. The system of claim 16, wherein said paid search content is analyzed and provided together with said search result only if said paid search content is determined to have word usage patterns matching word usage patterns of said query.

18. The system of claim 1, wherein said query pre-processing module includes a user interface adapted to at least one of:
provide a first entry field to receive input of said query, and includes a second entry field to receive input of context clue words;
provide to the user, a real-time cue as to which domains said system is construing said query to belong to;
render said query in a first color, and change said first color to a second color when said query is disambiguated; and
prompt the user to continue entering additional words related to said query to facilitate disambiguation thereof.

19. A computer implemented method for semantic search for electronic documents stored on a computer readable media, and providing a search result in response to a query, comprising:
providing a corpus including a plurality of electronic documents that are tagged at a document level to identify general domain of each electronic document, and are analyzed based at least partially on said tags to identify word usage patterns in said plurality of electronic documents;
providing an index of word usage patterns that indexes said plurality of electronic documents in said corpus according to word usage patterns and said domain tags of said plurality of electronic documents;
receiving a query from a user;
analyzing said query to derive probable word usage patterns in said query;
using said index to identify at least one of said electronic documents that has word usage patterns matching said probable word usage patterns in said query as a candidate electronic document; and
retrieving said candidate electronic document.

20. The method of claim 19, further including analyzing said retrieved candidate electronic document to determine exactness of match between said probable word usage patterns of said query and word usage patterns of said candidate electronic document.

21. The method of claim 20, further including identifying a plurality of candidate electronic documents that have matching word usage patterns.

22. The method of claim 21, further including ranking said retrieved candidate electronic documents based on exactness of match, and providing candidate electronic documents with the highest ranking as said search result.

23. The method of claim 19, wherein said plurality of electronic documents in said corpus are tagged essentially only at a document level.

24. The method of claim 19, further including clustering said word usage patterns based on similarity between said patterns.

25. The method of claim 20, further including disambiguating word sense in said query.

26. The method of claim 25, wherein analyzing said query includes at least one of eliciting contextual information from a user, receiving a selection of a word usage pattern or a set of synonyms from a user, and selecting a ranked, probabilistic word usage pattern.

27. The method of claim 25, wherein at least one of analyzing said query and analyzing said candidate electronic document includes at least one of:
selecting a topic and a sub-topic within a domain;
recognizing an ontological element;
selecting of a synonym or a set of synonyms;
determining interrogative type;
identifying a multiword term;
identifying a proper name;
correcting spelling and grammar of a multiple word pattern; and
performing semantic analysis of common verbs and adjectives.

28. The method of claim 25, wherein said processing of said candidate electronic document to determine exactness of match includes determining proximity of words of said query to each other in said candidate electronic document.

29. The method of claim 28, wherein said words of said query must be within a predetermined proximity range to each other within said electronic document in order to be provided as a search result.

30. The method of claim 29, wherein different types of words of said query are assigned different proximity ranges.

31. The method of claim 20, wherein said processing of said candidate electronic document to determine exactness of match includes determining word order match.

32. The method of claim 31, wherein determining word order match includes assignment of a word placement score based on said determined word order match.

33. The method of claim 32, wherein said word placement score is reduced a decreasing amount as number of intervening words increases.

34. The method of claim 19, further including providing paid search content together with said search result.

35. The method of claim 34, wherein said paid search content is analyzed and provided together with said search result only if said paid search content is determined to have word usage patterns matching word usage patterns of said query.

36. The method of claim 19, further including at least one of:
generating a first entry field to receive input of said query, and generating a second entry field to receive input of context clue words;
providing a real-time cue as to which domains said query is being searched;
rendering said query in a first color, and changing said first color to a second color when said query is disambiguated; and
prompting the user to continue entering additional words related to said query to facilitate disambiguation thereof.

37. A system for semantic search for electronic documents stored on a computer readable media, and providing a search result in response to a query, comprising:
a corpus of a plurality of electronic documents;
a tagging module that tags said plurality of electronic documents in said corpus at a document level to identify general domain of each electronic document;
a word usage module that determines word usage patterns in said plurality of electronic documents in said corpus based at least partially on said tags of said plurality of electronic documents; and
an indexing module that indexes said plurality of electronic documents in said corpus at least according to word usage patterns and domain tags.

38. The system of claim 37, further including a query pre-processing module that receives a query from a user, and analyzes said query to determine probable word usage patterns in said query.

39. The system of claim 38, further including a processor that identifies at least one indexed electronic document having word usage patterns that matches said probable word usage patterns in said query as a candidate electronic document, and retrieves said candidate electronic document.

40. The system of claim 39, further including a post-processing module that analyzes said retrieved candidate electronic document to determine exactness of match between said probable word usage patterns of said query and word usage patterns of said candidate electronic document.

41. The system of claim 38, wherein said query pre-processing module disambiguates word sense in said query to identify general domain of said query.

42. A computer implemented method for semantic search for electronic documents stored on a computer readable media, and providing a search result in response to a query, comprising:
providing a corpus of a plurality of electronic documents;
tagging said plurality of electronic documents in said corpus at a document level to identify general domain of each electronic document;
determining word usage patterns in said plurality of electronic documents in said corpus based at least partially on said tags of said plurality of electronic documents; and
generating an index of word usage patterns that indexes said plurality of documents in said corpus according to said word usage patterns and said domain tags of said plurality of electronic documents.

43. The method of claim 42, further including receiving a query from a user, and analyzing said query to derive probable word usage patterns in said query.

44. The method of claim 43, further including using said generated index to identify at least one of said electronic documents that has word usage patterns matching said probable word usage patterns in said query as a candidate electronic document, and retrieving said candidate electronic document.

45. The method of claim 44, further including analyzing said retrieved candidate electronic document to determine exactness of match between said probable word usage patterns of said query and word usage patterns of said candidate electronic document.

46. The method of claim 43, further including disambiguating word sense in said query to identify general domain of said query.

47. A computer readable medium with executable instructions for semantic search for electronic documents stored on a computer readable media, and providing a search result in response to a query, comprising:
instructions for receiving a query from a user;
instructions for analyzing said query to derive probable word usage patterns in said query;
instructions for accessing an index of word usage patterns that indexes a plurality of electronic documents according to word usage patterns in said plurality of electronic documents, said plurality of electronic documents being tagged at a document level to identify general domain of each electronic document;
instructions for identifying at least one of said electronic documents that has word usage patterns matching said probable word usage patterns in said query as a candidate electronic document; and
instructions for retrieving said candidate electronic document.

48. The computer readable medium of claim 47, further including instructions for analyzing said retrieved candidate electronic document to determine exactness of match between said probable word usage patterns of said query and word usage patterns of said candidate electronic document.

49. The computer readable medium of claim 48, further including instructions for identifying a plurality of candidate electronic documents that have matching word usage patterns.

50. The computer readable medium of claim 49, further including instructions for ranking said retrieved candidate electronic documents based on exactness of match, and providing candidate electronic documents with the highest ranking as a search result.

51. The computer readable medium of claim 47, further including instructions for clustering said word usage patterns based on similarity between said patterns.

52. The computer readable medium of claim 47, further including instructions for disambiguating word sense in said query.

53. The computer readable medium of claim 52, wherein instructions for analyzing said query includes instructions for at least one of eliciting contextual information from a user, receiving a selection of a word usage pattern or a set of synonyms from a user, and selecting a ranked, probabilistic word usage pattern.

54. The computer readable medium of claim 52, wherein at least one of said instructions for analyzing said query and instructions for analyzing said candidate electronic document includes instructions for at least one of:
selecting a topic and a sub-topic within a domain;
recognizing an ontological element;
selecting of a synonym or a set of synonyms;
determining interrogative type;
identifying a multiword term;
identifying a proper name;
correcting spelling and grammar of a multiple word pattern; and
performing semantic analysis of common verbs and adjectives.

55. The computer readable medium of claim 48, wherein said instructions for processing of said candidate electronic document to determine exactness of match includes instructions for determining proximity of words of said query to each other in said candidate electronic document.

56. The computer readable medium of claim 55, wherein said words of said query must be within a predetermined proximity range to each other within said electronic document in order to be provided as a search result.

57. The computer readable medium of claim 56, wherein different types of words of said query are assigned different proximity ranges.

58. The computer readable medium of claim 55, wherein said instructions for processing of said candidate electronic document to determine exactness of match includes instructions for determining word order.

59. The computer readable medium of claim 58, wherein instructions for determining word order match includes instructions for assignment of a word placement score based on said determined word order match.

60. The computer readable medium of claim 59, wherein said instructions for determining word placement score includes instructions for reducing said word placement score a decreasing amount as number of intervening words increases.

61. The computer readable medium of claim 47, further including instructions for providing paid search content together with a search result.

62. The computer readable medium of claim 61, further including instructions for providing said paid search content together with said search result only if said paid search content is determined to have word usage patterns matching word usage patterns of said query.

63. The computer readable medium of claim 47, further including instructions for at least one of:
generating a first entry field to receive input of said query, and instructions for generating a second entry field to receive input of context clue words;
providing a real-time cue as to which domains said query is being searched;
rendering said query in a first color, and changing said first color to a second color when said query is disambiguated; and
prompting the user to continue entering additional words related to said query to facilitate disambiguation thereof.

64. A computer readable medium with executable instructions for semantic search for electronic documents stored on a computer readable media, and providing a search result in response to a query, comprising:
instructions for accessing a corpus of a plurality of electronic documents;
instructions for tagging said plurality of electronic documents in said corpus at a document level to identify general domain of each electronic document;
instructions for determining word usage patterns in said plurality of electronic documents in said corpus based at least partially on said tags of said plurality of electronic documents; and
instructions for generating an index of word usage patterns that indexes said plurality of documents in said corpus according to said word usage patterns and said domain tags of said plurality of electronic documents.

65. The computer readable medium of claim 64, further including instructions for receiving a query from a user, and analyzing said query to derive probable word usage patterns in said query.

66. The computer readable medium of claim 65, further including instructions for using said generated index to identify at least one of said electronic documents that has word usage patterns matching said probable word usage patterns in said query as a candidate electronic document, and retrieving said candidate electronic document.

67. The computer readable medium of claim 66, further including instructions for analyzing said retrieved candidate electronic document to determine exactness of match between said probable word usage patterns of said query and word usage patterns of said candidate electronic document.

68. The computer readable medium of claim 65, further including instructions for disambiguating word sense in said query to identify general domain of said query.
